(19) United States
(12) Patent Application Publication
(10) Pub. No.: US 2011/0251861 A1
(43) Pub. Date: Oct. 13, 2011

(54) COMPUTER BASED METHOD OF MANAGING, SAVING FOR, AND ARRANGING TRAVEL

(76) Inventor: Heddi Cundle, San Francisco, CA (US)

(21) Appl. No.: 12/759,289

(22) Filed: Apr. 13, 2010

(51) Int. Cl. G06Q 50/00; G06F 15/16; G06Q 30/00; G06Q 20/00; G06Q 40/00

(52) U.S. Cl. 705/5; 709/204

(57) ABSTRACT

The invention is a computer-based method of saving for and booking travel arrangements. The method includes a full service travel website and computer accessible interest bearing bank account that is set up for the express purpose of saving funds for future travel. The method includes a reward system that allows users to pay for travel with the savings account funds, interest from the account, and the rewards points.

### FIELD OF INVENTION

This invention relates, generally, to a computer-based method of saving funds for travel expenses and booking trips using the saved fund. More particularly, the invention is a computer-based travel account bank that encourages saving for travel and booking green travel options using the travel savings account.

### BACKGROUND

The proliferation of the internet has included various types of travel comparison, shopping, and booking websites. Travel comparison website providers, such as Expedia® and Tavelocity®, allow users compare prices for hotels, airline flights, rental cars, and other travel related items. These travel comparison website providers primary focus is on providing users with a list of current prices to compare as they look to book travel arrangements. The ability for the consumer to compare prices has led to an over emphasis on price by the consumer and the travel comparison website provider. Moreover, the prices displayed on any particular travel comparison website is often the same on any of the other travel comparison websites.

Because the travel provider, such as the airlines and hotels, have their own website, users of the travel comparison websites will frequently go to the provider websites directly to see if the price is the same and, if it is the same or less, book the travel directly with the provider. Indeed, consumers will often visit several comparison websites and provider websites before booking travel arrangements. The ability for users to quickly compare several websites and the ability of the travel providers to undercut the travel comparison websites has led to a lack of loyalty among consumers to a particular travel comparison website. Price, rather than loyalty is the driving concern.

One method of encouraging loyalty to a particular travel provider or website is the reward granting frequent user system. With this system, a user is rewarded for her frequent use of a travel provider. When enough reward points are generated, the user can use the reward points to book travel with that particular provider. Although this helps with loyalty, there is still a good chance that the user may forgo the opportunity to get rewards points if the cost of using another provider is less than the reward granting provider.

Another issue not addressed by the travel providers or comparison websites is promoting green travel. Due to the current concern for the environment that many consumers have, many travelers have expressed a desire to travel in a more ecological or environmental friendly way. However, neither the providers nor the comparison websites offer information on how green a particular travel option may be or offer incentives to select that green travel option.

There are numerous references that disclose methods of using a computer to aid a traveler in comparing and booking travel arrangements. For example, U.S. Pat. No. 5,948,040, issued to DeLorme, U.S. Pat. No. 7,599,847, issued to Block, and U.S. Published Application No. 2002/0010604, filed by Block, disclose various travel reservation, information, and planning systems for individuals. In the area of corporate planning and management of business travel, U.S. Pat. No. 6,442,526 to Vance discloses a system and method for processing travel data and travel receipts for the business traveler. Finally, U.S. Published Application No. 2001/0037243, filed by Rouston, discloses a system for accruing and redeeming frequent flyer miles.

Although the above references disclose various options for customers to book travel arrangements, compare prices, and redeem rewards, none of the references is directed towards, or even hints at a computer aided method that would reward loyalty, offer green travel alternatives, allow users access to discounted travel, and provide a special travel account to save up money for future travel.

### SUMMARY OF THE INVENTION

To minimize the limitations in the prior art, and to minimize other limitations that will become apparent upon reading and understanding the present specification, the present invention discloses a computer-aided method of saving funds for travel expenses and booking travel arrangements using the saved fund.

One embodiment of the invention is a computer-based method of managing travel arrangements, the steps comprising: registering on a computer by a user on a system for managing travel; wherein said system for managing travel is on a server; creating a designated travel savings account; linking said designated travel savings account to said system for managing travel; accessing on said computer by said user said system for managing travel; providing on a computer a plurality of travel options on said system for managing travel to said user accessing said system for managing travel; selecting by said user one or more of said plurality of travel options on said system for managing travel; and paying for said selected one or more travel options from a set of saved funds in said designated travel savings account.

Preferably the steps further comprise: rewarding said user with one or more rewards points. The reward points may be based on saving a plurality of funds in said designated travel savings account, donating to a charity, donating to a carbon offset, purchasing travel insurance from said system for managing travel with said set of saved funds in said designated travel savings account, or purchasing selected one or more travel options from said system for managing travel with said set of saved funds in said designated travel savings account. The rewards points may be used by said user to offset paying for said selected one or more travel options.

Preferably the travel options provided on said system for managing travel to said user accessing said system for managing travel includes green travel options. The designated travel savings account preferably accrues interest. The user and any third party may add additional funds to said set of saved funds in said designated travel savings account. The travel options preferably include one or more exclusive deals to registered users from a plurality of travel providers.

The computer-based method of managing travel arrangement preferably include the steps of: providing a calendar alert function within said system for managing travel; inputting a plurality of calendar alert data into said calendar alert function; wherein said plurality of calendar alert data is selected from the group consisting of future trip data, wish list data, third party gift giving data, personal gift giving data, popular event data, available funds data, funds needed to book a future trip data, and exclusive deals data; notifying said user by said calendar alert function of one or more of said plurality of calendar alert data; modifying and updating said plurality of calendar alert data; personalizing said system for managing travel; and personalizing said plurality of calendar alert data. The user may be notified by said calendar alert function of one or more of said plurality of calendar alert data by an email notification, a text notification, a smart phone application notification, or a desktop application notification.

Various embodiments of the invention improve the ability of individuals and businesses to fund their travels objectives. The invention provides for a designated savings account and a reward system for using the savings account to save for and pay for travel arrangements.

Because the savings account allows for the user and any third party to add funds to the savings account, the account makes an excellent way to give gifts to an account holder.

It is an objective of the invention to psychologically separate general everyday savings from travel savings, which encourages travel objectives to be reached.

The inventive method allows for registered members get rewarded for the amount of money they have in their account. The rewards points are preferably only spendable on the full service online travel website. In order to encourage ecologically friendly travel, the users can also get rewards points by making a carbon offset donation or an ecologically friendly or green donation. Rewards points are also granted based on actual travel purchases and travel insurance purchases.

It is also an object of the present invention to provide a calendar and alert system to allow users to set up reminders and receive alerts regarding their travel plans.

Another object of the invention is to leverage the funds in the various travel accounts of the members to provide exclusive and bargain deals to the members.

Another object of the invention is to engender the loyalty of the members so that they use the present invention to save for and book all of their travel.

The present invention will revolutionize the way individuals and businesses plan and pay for travel. The present invention will be accessible via social media outlets or via smart phone or computer applications.

### BRIEF DESCRIPTION OF THE DRAWINGS

FIG. 1 is a flow block diagram and shows the initial registration steps of one embodiment of the present invention.

FIG. 2 is a flow block diagram and shows the reward points system of one embodiment of the present invention.

FIG. 3 is a flow block diagram and shows possible mood color themes to personalize the graphical user interface of one embodiment of the present invention.

FIG. 4 is a flow block diagram and shows calendar options of one embodiment of the present invention.

FIG. 5 is a flow block diagram and shows calendar alert receiving options of one embodiment of the present invention.

FIG. 6 is a flow block diagram and shows how to book new travel options of one embodiment of the present invention.

FIG. 7 is a flow block diagram continuing from FIG. 6 and shows how to book new travel options of one embodiment of the present invention.

FIG. 8 is a flow block diagram and shows travel alerts options of one embodiment of the present invention.

FIG. 9 is a flow block diagram continuing from FIG. 8 and shows travel alerts options of one embodiment of the present invention.

FIG. 10 is a flow block diagram and shows general alert options of one embodiment of the present invention.

FIG. 11 is a flow block diagram and shows smart phone applications of one embodiment of the present invention.

FIG. 12 is a flow block diagram and shows the desktop application options of one embodiment of the present invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “computer” refers to any device that processes information with an integrated circuit chip, including without limitation, mainframe computers, work stations, servers, desktop computers, portable computers, laptop computers, embedded computers, wireless devices including cellular phones, personal digital assistants, and portable game players, and hand-held computers; “internet” refers to any collection of networks using standard protocols, whether Ethernet, ATM, FDDI, Wi-fi, Token ring, or any combination thereof; and “website” refers to any document written in a mark-up language including, but not limited to, HTML (hypertext mark-up language) or VRML (virtual reality modeling language), dynamic HTML, XML (extended mark-up language), WML, or any other computer languages related thereto, as well as to any collection of such documents reachable through one specific Internet Protocol Address or at one specific World Wide Web site, or any document obtainable through any particular URL (Uniform Resource Locator); and “web page” (or “page”) refers to any of the various documents and resources on the World Wide Web, in HTML/XHTML format with hypertext links to enable navigation from one page or section to another, or similar such resources used on the internet. The term “social media” refers to media that is designed to be disseminated through social interaction, preferably using accessible and scalable publishing techniques. Social media is typically a website where members load profiles and meet and interact in various manners with other members.

The method of the present invention requires a user to use a computer or smart phone to access most of the functions of the full service travel website and designated savings account.

The system for managing travel of the present invention is preferably called TAB™, which stands for Travel Account Bank. The present invention includes a saving platform for individuals and/or businesses to manage funds in order to book future travel. The travel is preferably accessed at a specific designated website. The website provides a graphical user interface with which the user accesses, via a computer, the features of the present invention.

The travel website and system of the present invention is linked to a designated savings account. The funds of the account are placed in the account by the user, or other third parties, for the express purpose of being spent on travel. More specifically, to be used to purchase travel through the travel website and system of the present invention. The designated savings account is preferably an online account, such as a PayPal® money market account. However, any type of online or bank account may be used, so long as the account can be accessed by the user, have funds added via an online portal, and so long as the account can be linked to the travel website and system of the present invention.

Preferably the account generates interest (monthly, annually, etc.). The user can elect to have the interest roll into the account or be used for another purpose, such as donating to a charity or donating to offset the carbon footprint of the user's travel plans.

The travel website and system of the present invention includes a calendar of options to alert the user, and possibly other members, as approved by the user and allowed by the system, of numerous, customized travel related planning the user has requested to receive.

The calendar alerts preferably provide users with early-bird purchase options, including ecologically friendly purchase options, which may take into account the existing funds in the account, along with a multitude of additional features including group travel correspondence and budgetary notifications.

Non-registered members of the travel website and system may use the system, but they do not get the benefit of the exclusive deal or the rewards points.

Preferably the present invention includes an application that allows the invention to be accessed or controlled through a smart phone application. Although these smart phone applications have a narrower set of features.

The travel website and system of the present invention also provides the option for members to donate at a regular basis to various ecologically friendly charities.

The travel website and system of the present invention generates revenue from online booking commissions, as is well known in the art of travel websites.

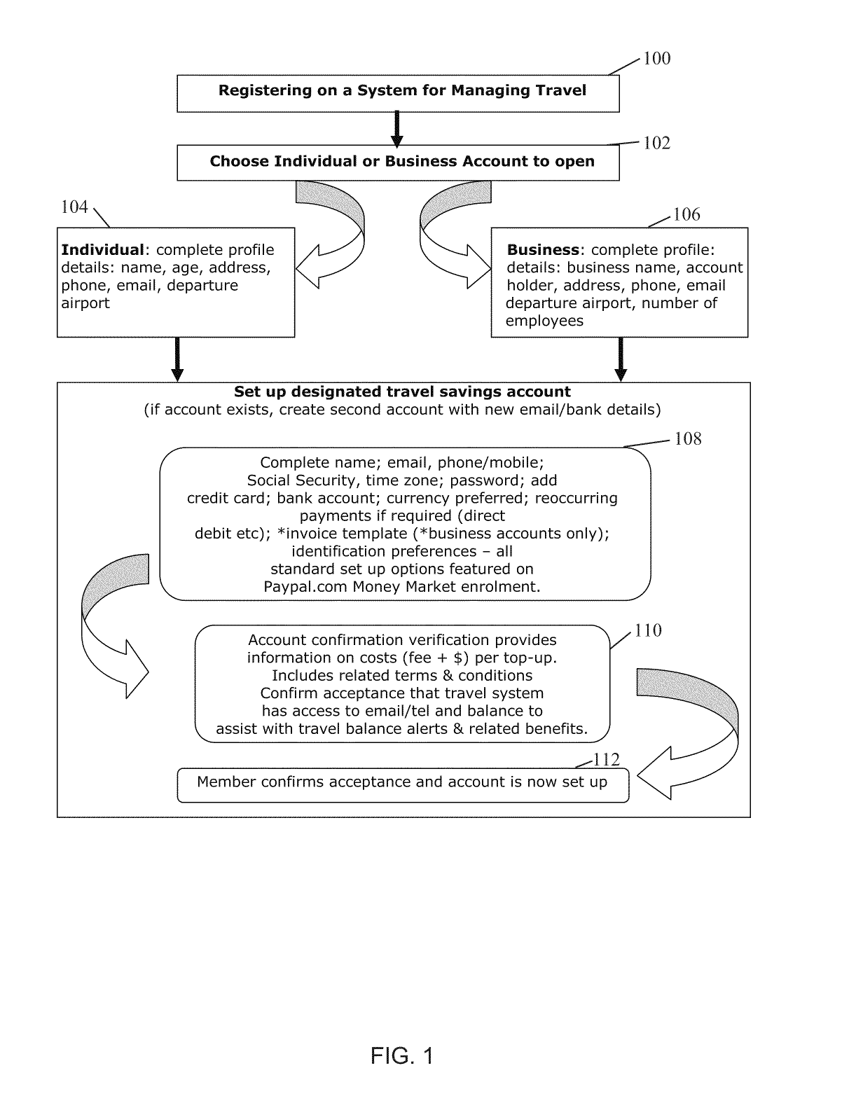

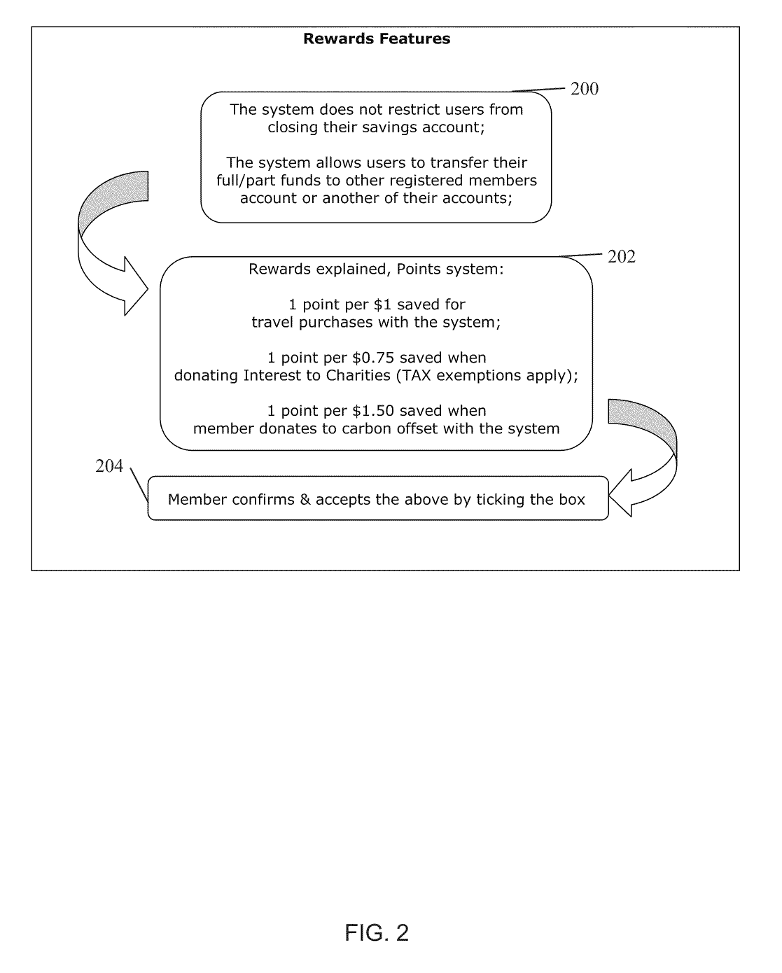

FIG. 1 is a flow block diagram and shows the initial registration steps of one embodiment of the present invention. As shown in FIG. 1, a user first registers as a member on a system for managing travel 100. The user accesses the system via computer or smart phone. The user opens a business or an individual account 102. If the user is an individual, she inputs profile details, including name, age, address, phone, email, and local departure airport 104. If the user is a business, it provides, name, account holders, address, phone, email, departure airports, and number of employees 106. The next step of the method is to provide, or otherwise set up and designate a travel savings account. The user provides information for the account, including name, email, phones, social security number, time zones, usernames, passwords, credit cards, account number, currency in which transactions will be performed, reoccurring payments or withdrawals, invoice templates, identification preferences, and any other options that are standard features of savings accounts 108. The account information set up and verification preferably includes accepting terms and conditions, including any fees associated with the account, linking the savings account to travel system, and acceptance that the travel system has access to all of the account information 110. Once the member confirms acceptance, the account is set up 112 and the user can input calendar information and personalize the system interface. The set up of the system is continued on FIG. 2.

FIG. 2 is a flow block diagram and shows the reward points system of one embodiment of the present invention. As shown in FIG. 2, although the funds in the designated savings account are preferably only spent on travel, the system will not necessarily restrict users from closing the savings account or use the funds for other things. Additionally, the user can also transfer their funds into any other registered members' accounts 200. FIG. 2 also shows the preferred reward points system 202. The user gains one (1) reward point for every dollar saved in the designated savings account, and/or used for travel purchases with the travel system. One (1) reward point for each $0.75 that is donated to a charity, preferably an ecologically friendly charity. Additionally, one (1) reward point is gained for every $1.50 that is donated to offset the users travel carbon footprint. It should be understood that reward points may also be granted for many other activities, including purchasing travel insurance from the travel system.

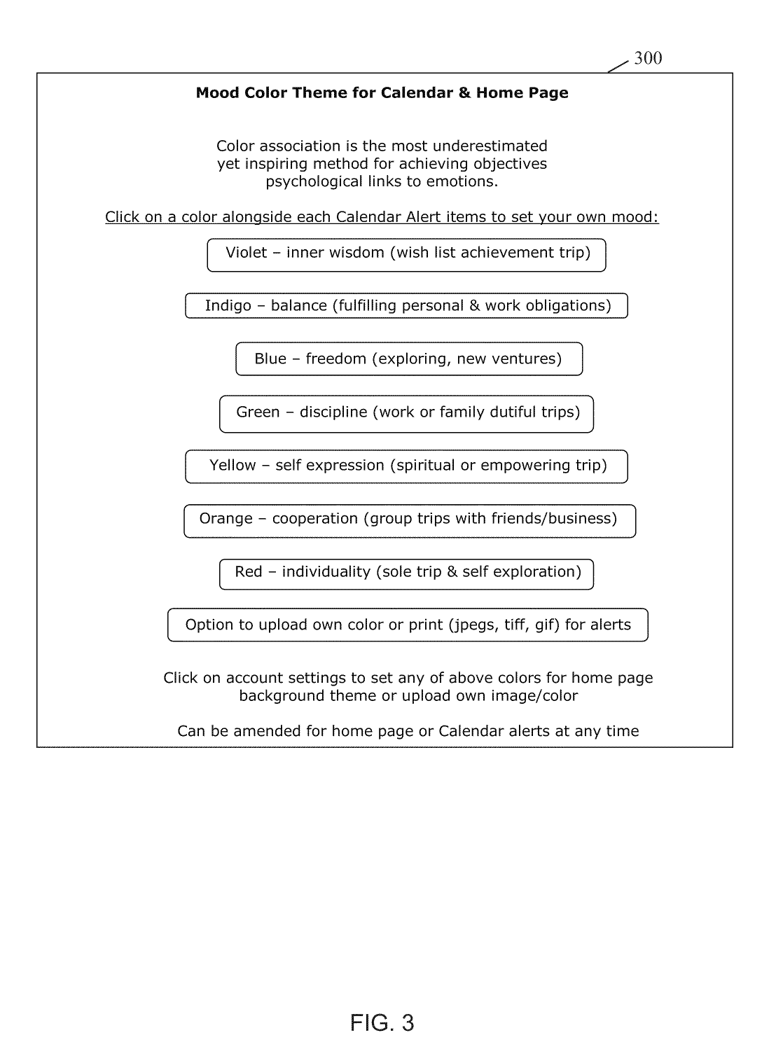

FIG. 3 is a flow block diagram and shows possible mood color themes to personalize the graphical user interface of one embodiment of the present invention. As shown in FIG. 3, the user preferably personalizes her graphical user interface with the system. This personalization includes associating colors with each calendar alert item 300. The colors include, but are not limited to Violet, Indigo, Blue, Green, Yellow, Orange, or Red. Each of these colors, as shown in FIG. 3, relate to a mood or have special meeting. The user may also upload her own custom colors. The events associated with the colors may be amended at any time by the user.

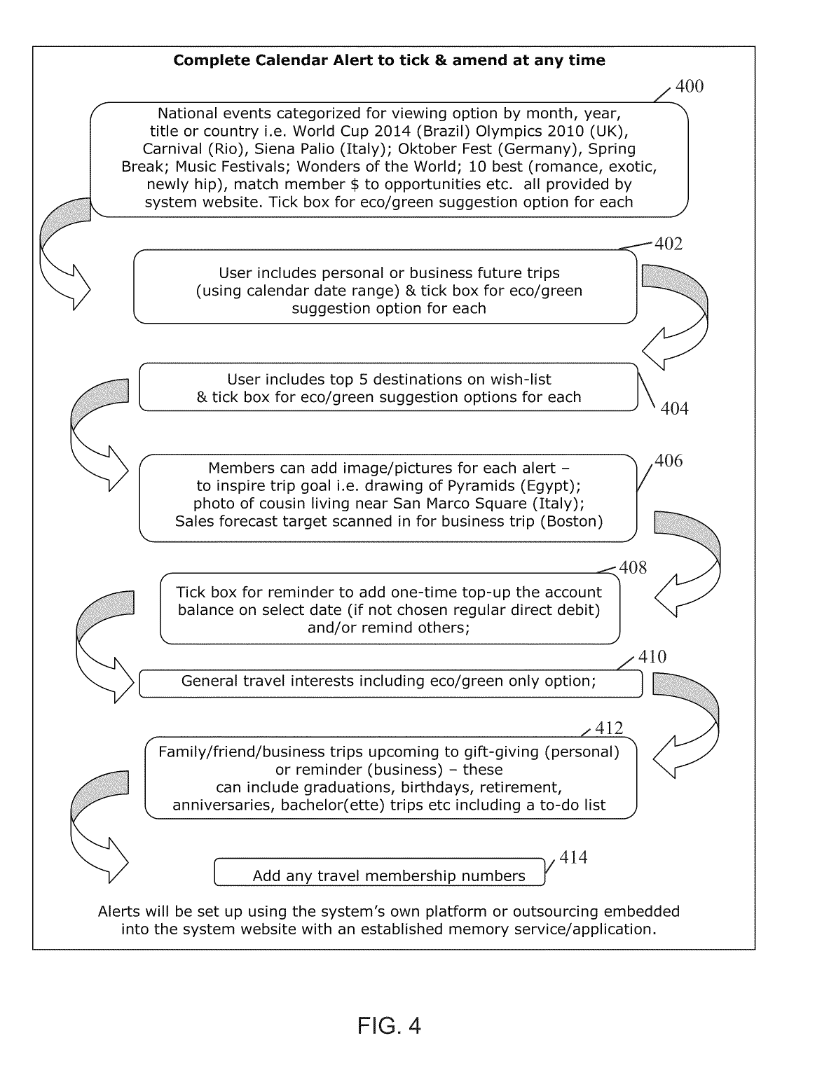

FIG. 4 is a flow block diagram and shows calendar options of one embodiment of the present invention. FIG. 4 continues to detail the set up of the travel system. The user is able to calendar many types of events, including large international or national events, such as the World Cup 400. If preferred, the user can set up an additional option of having green travel suggestions as part of any event calendar entry. The events calendared are typically suggested to the user by the system, or generated by the user. User generated events include personal or business future trips 402. The user also preferably selects a wish list with that persons top five destinations 404. The calendared events are preferably personalized, where the member can add images or pictures for each alert 406. The user can also set a reminder to add to the savings account at select dates 408. This can reminder can be sent to other users or friends and family. This reminder system is especially useful if the user does not have a reoccurring deposit into the account from a regular paycheck or another account. The user may calendar her general travel interests, including whether she wants to travel using green options only 410. The user can also calendar her friends and family's gift-giving dates, such as graduations, anniversaries, retirements, and birthdays 412. The user may also add travel membership numbers 414. Finally, the calendar alerts may be set up using the system's own platform or calendar, or it may be imported into the system through the system website with an established memory service or application.

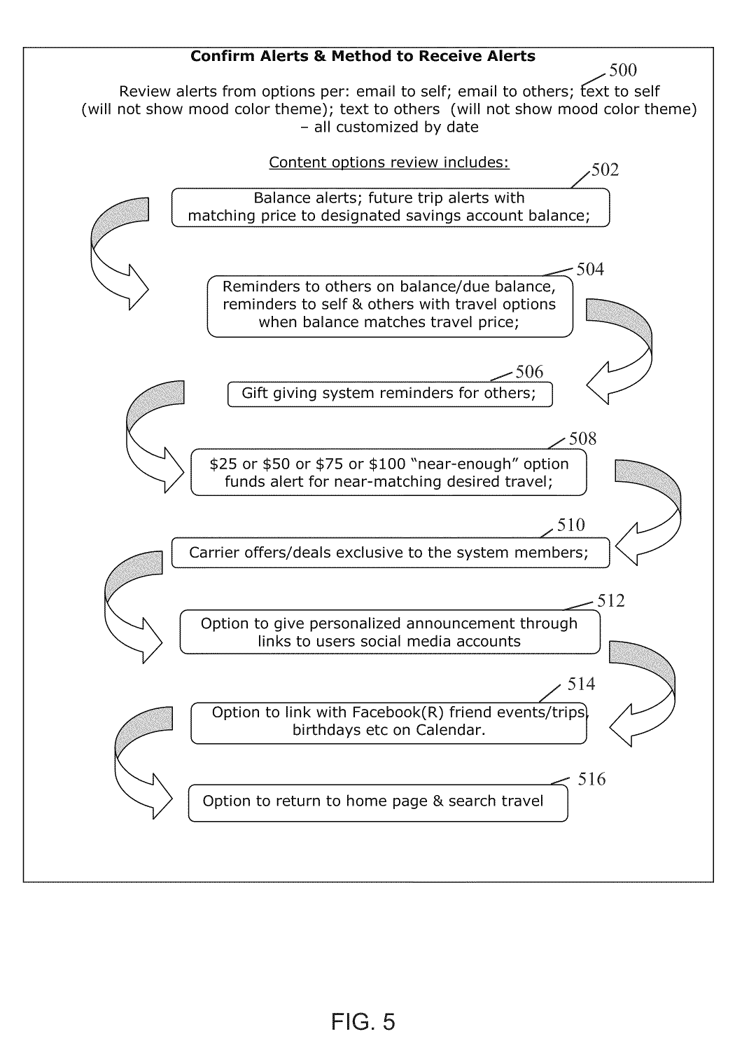

FIG. 5 is a flow block diagram and shows calendar alert receiving options of one embodiment of the present invention. FIG. 5 shows how the user determines how the alerts are sent, such as email to self, email to others, text to self, or text to others 500. Any alert sending system may be used. The alerts are preferably confirmed and reviewed by the user. The contents of the alert are preferably determined. The alert may include account balance information 502. The alerts sent to others may disclose the current balance, a needed amount to complete a goal, or the current travel options now that a current balance has been reached 504. The calendar system allows the user to set gift giving reminders for others 506. Preferably the calendar alert function has a “near-enough” option for when the amount in the account is almost at a level that will allow for travel goal to be met 508. The calendar alert function allows a user to request offers and reminder about carrier offers and exclusive member deals 510. The user may also sign up to get personalized announcements through social media accounts, such as Facebook® 512. The user may also use the calendar alert function to send announcements to others through social media websites 514. Once the user has set all of her alerts, she has the option to return to the homepage of the travel system website or go to the search page 516.

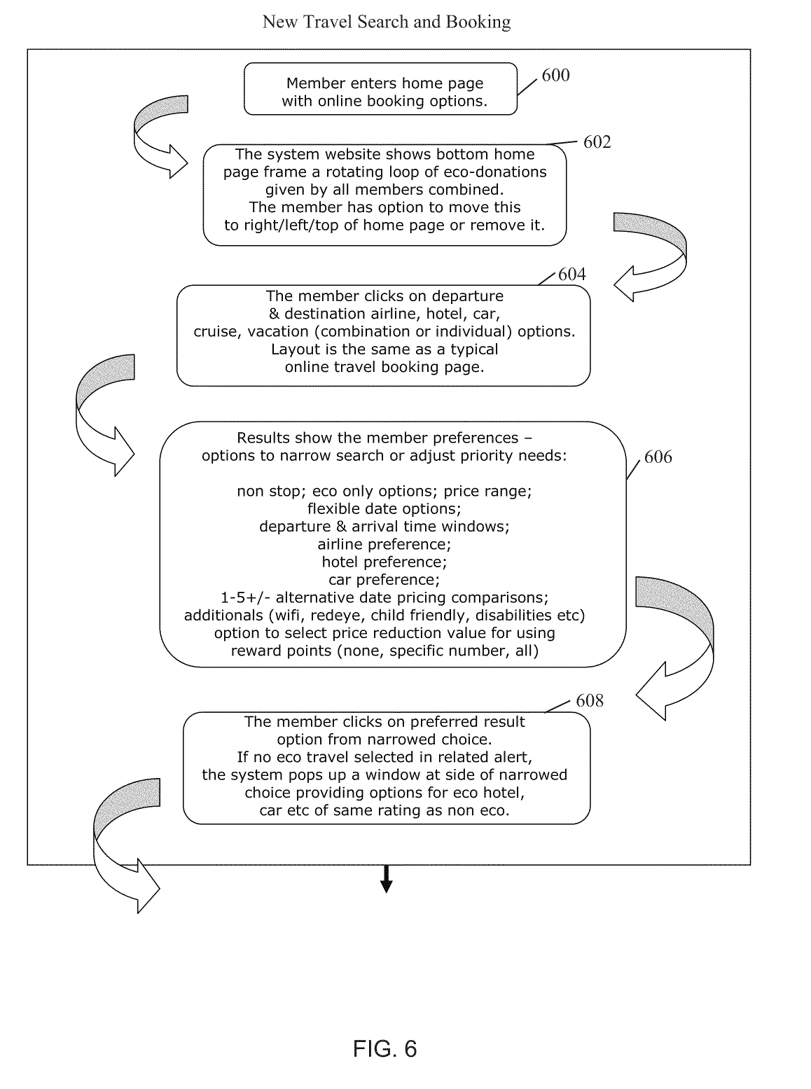

FIG. 6 is a flow block diagram and shows how to book new travel options of one embodiment of the present invention. After the user has set up and calendared alerts, the preferred next step of the present invention is to book travel arrangements. The member accesses the travel system website by signing in at the home page 600. The home page allows members to look up travel options. Preferably the homepage has a rotating loop banner of eco-donations given by members 602. This banner may be removed or moved to any location of the homepage. Similar to other full service travel websites, the members are provided with a plurality of travel options which are selected by the member. The member may click on departure and destination airports, select an airline, hotel, car, cruise, or other travel or vacation option 604. The homepage will preferably reflect each individual's preferences and has other options to narrow the member's search or otherwise adjust to the priorities or needs of the member 606. These preferences may include non-stop, ecologically friendly only options, price ranges, flexible date options, departure and arrival time windows, airline preferences, hotel preferences, rental car preferences, alternative date pricing comparisons, wifi availability, redeye flight, pet friendly, child friendly, disability accessible, and the ability to use reward points to reduce the price of the option 606. The member clicks on the preferred options from the narrowed choices 608. If the user does not select any of the environmentally or ecologically friendly options, the system preferably has a pop-up website window that details the eco-friendly options that are comparable to the option selected. The steps for booking are continued in FIG. 6.

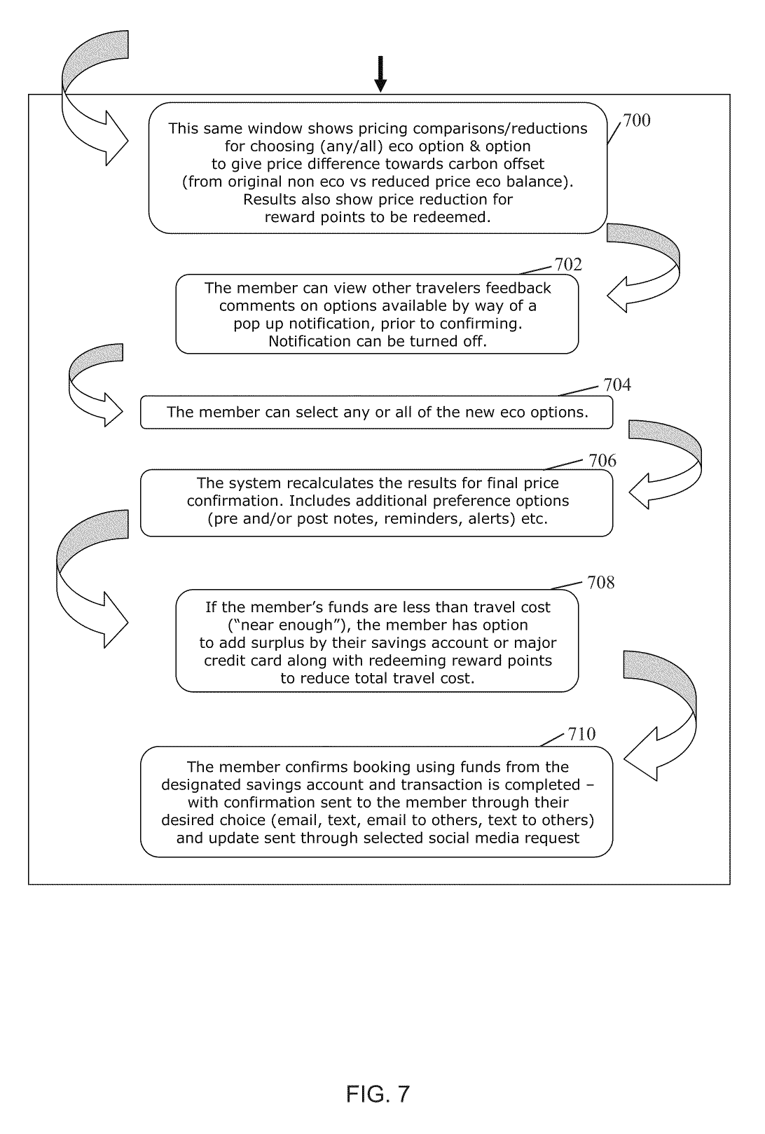

FIG. 7 is a flow block diagram continuing from FIG. 6 and shows how to book new travel options of one embodiment of the present invention. The same pop-up website window of 608 preferably shows pricing comparisons for choosing the eco-friendly option and how much would need to be spent towards a carbon offset for choosing the non-eco-friendly option 700. The website also allows the member to view comments and feedback by other members who have selected the same options 702. This option may be turned off if desired. Once the eco-friendly option pops-up, the user may change to the eco-friendly option by clicking on it 704. The system would then recalculate the final price 706. If the member does not have enough funds in the designated savings account the user can transfer funds into the account using an online payment option to replenish the designated savings account, a credit card, or possibly rewards points 708. The member confirms the booking and pays for the travel with funds from the designated savings account 710. A confirmation is sent to a member via the desired method, such as email, text, or social media 710.

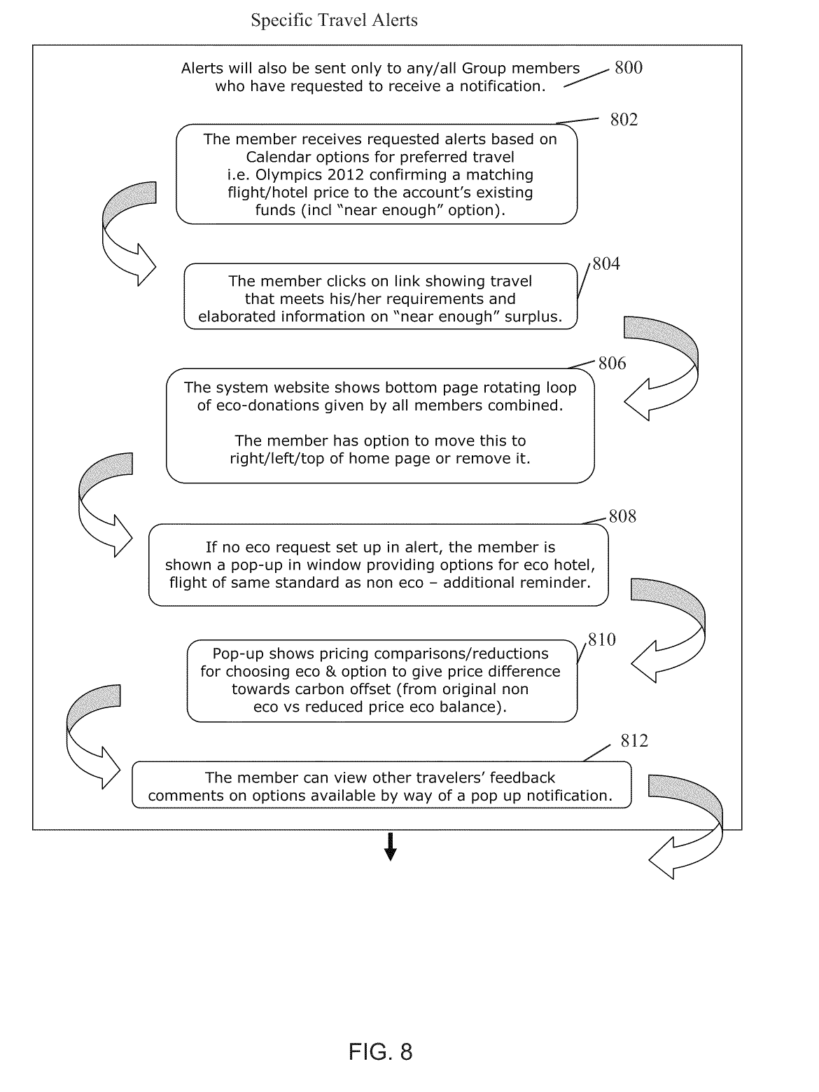

FIG. 8 is a flow block diagram and shows travel alerts options of one embodiment of the present invention. The user is able to set up specific alerts and reminders based on the specific travel booked. These alerts may also be sent to any groups of other members who have been requested to receive the alerts 800. The user may receive an alert based on a desired calendar option 802. The member may click on the link showing travel that meets her requirements and other payment information 804. As discussed previously, the system also may show the eco-friendly donations by members 806. If the user has not set up any eco-friendly alerts, the user is shown in a pop-up window the eco-friendly options that were not shown, or not selected 808. This option promotes eco-friendly options. The pop-up shows the price comparison and how much would need to be donated to a carbon offset if the non-eco-friendly option is selected 810. It is hoped that the user goes back to select the eco-friendly option once she sees how much better for the environment the eco-friendly option is. The member may also view other user's feedback and comments on the options that are displayed 812.

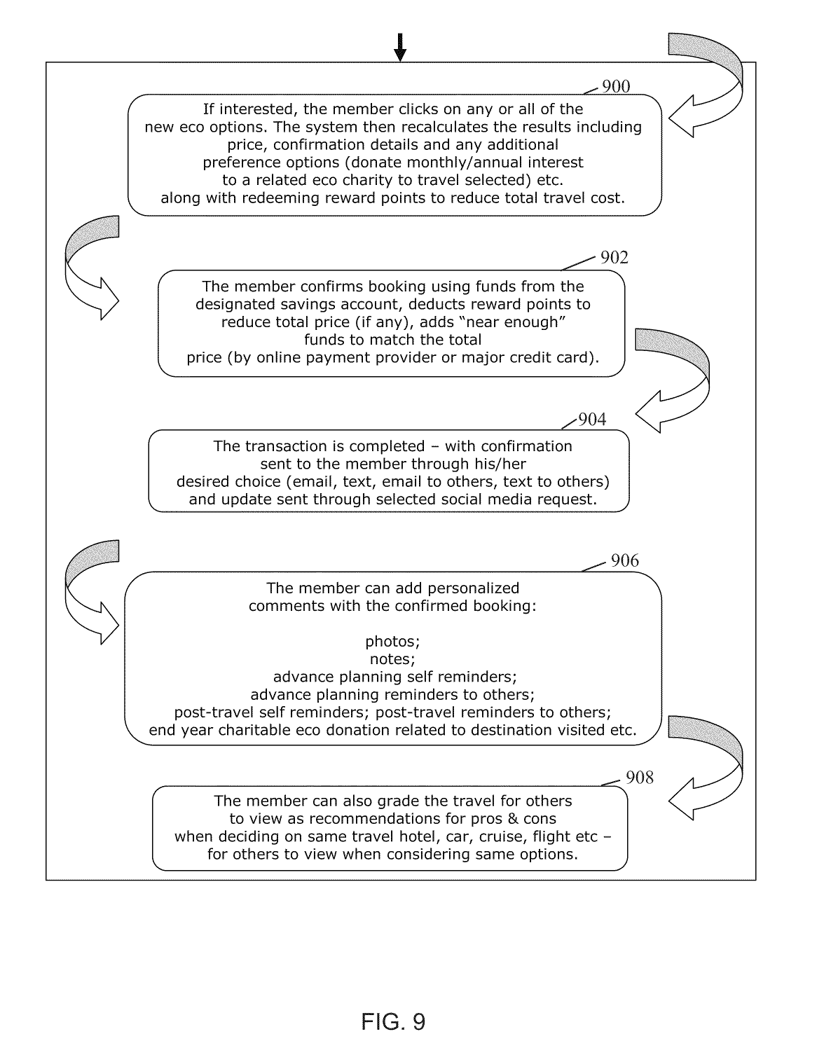

FIG. 9 is a flow block diagram continuing from FIG. 8 and shows travel alerts options of one embodiment of the present invention. FIG. 9 shows that if the member is interested, she may click on any or all of the new eco-friendly options 900. The system recalculates the price based on the new options and confirms the new details and other options related to choosing the eco-friendly option. The system also allows reward points to be redeemed, which may not have been redeemable before selecting the eco-friendly option. The user confirms the booking by paying with funds in the designated savings account 902. Once the transaction is completed the user and any other designated third parties receive a confirmation via one or more selected means, such as email or text 904. The rewards points are preferably taken into consideration along with any additional funds that may be needed if the designated travel savings account does not have enough funds. The member can add personalized comments to the confirmed booking, such as photos, notes, advanced planning self reminders, advanced planning reminders to others, post travel self reminders, post travel reminders to others, and reminders to donate to an eco-friendly charity to offset the carbon footprint generated by the travel 906. Finally, the member can comment, grade, or otherwise provide feedback on the selected travel option for other members to review 908.

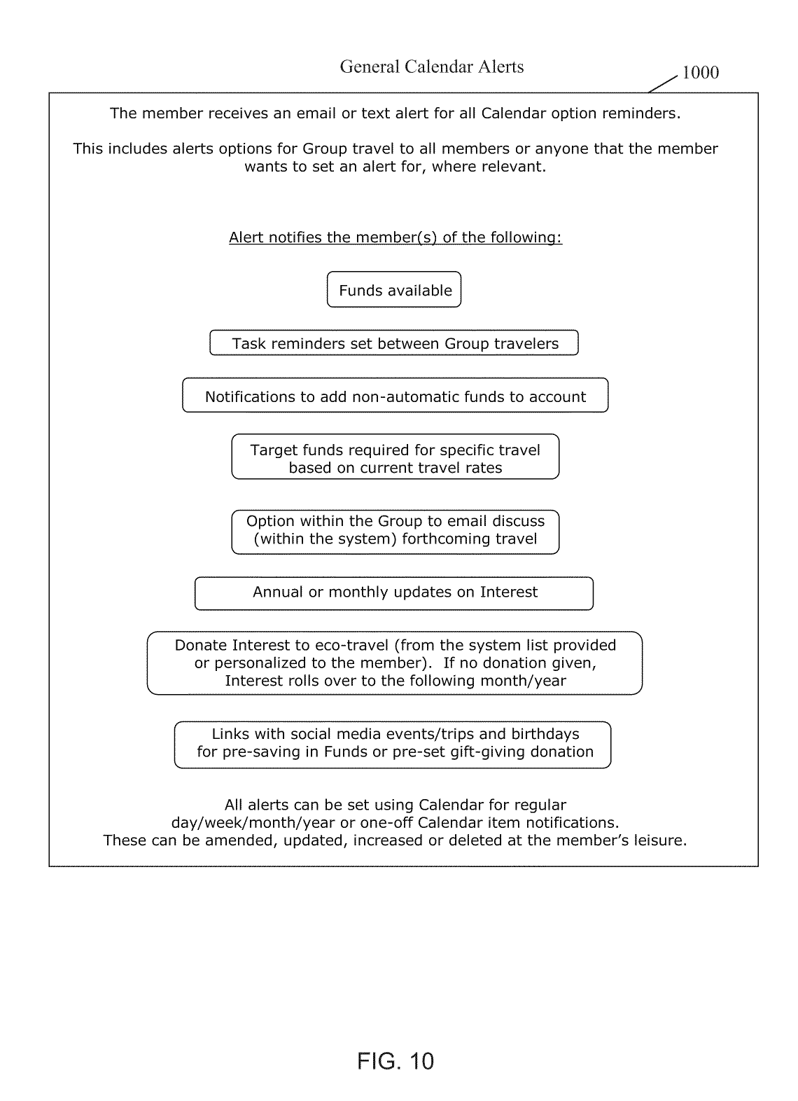

FIG. 10 is a flow block diagram and shows general alert options of one embodiment of the present invention. Preferably the member receives general calendar alerts 1000. The member and or third parties receive an email or text alert of the selected calendar alert reminders. The alert may be sent a designated group. The alert may include, but is not limited to the following: funds available; group task reminders; notifications to add funds to the designated savings account; the amount of funds needed for specific travel (based on current travel rates); group discussion reminders; interest accrued; donation related reminders; reminders to link with social media websites for special events, such as birthdays or preplanned trips. The alerts can be amended, updated, or deleted via the travel website of the present invention.

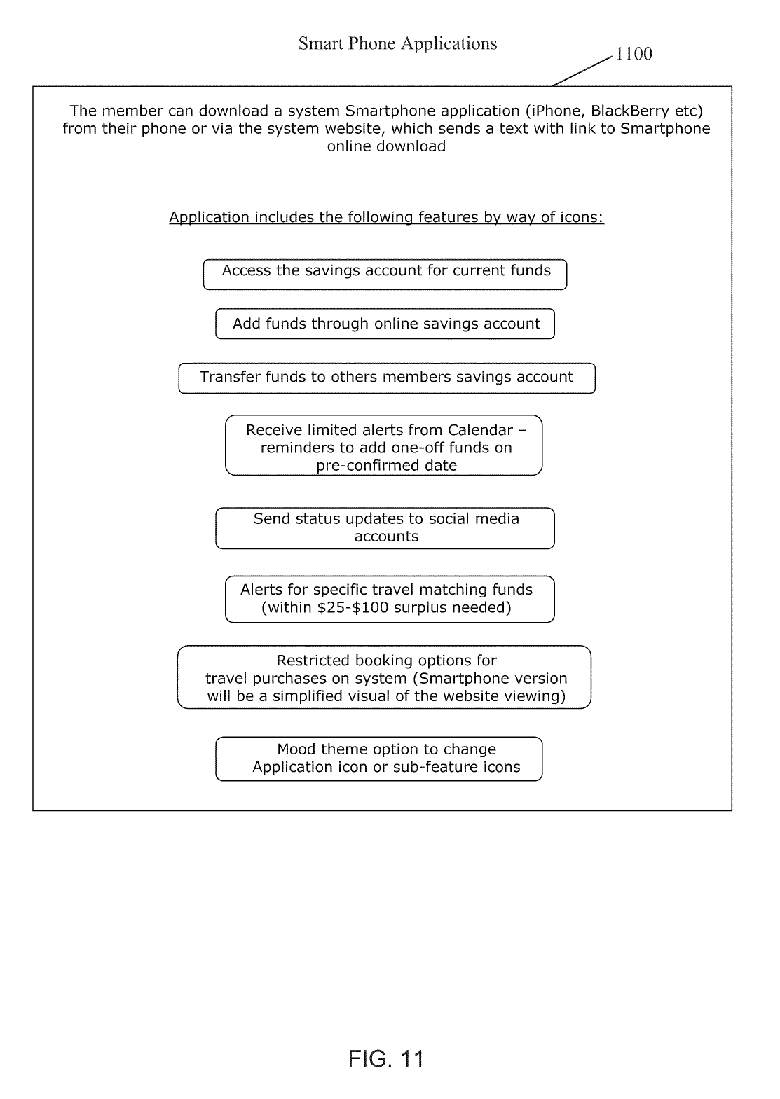

FIG. 11 is a flow block diagram and shows smart phone applications of one embodiment of the present invention. Rather than accessing the system through a computer, the user may access the travel system through a smart phone 1100. This typically requires the user to download an application enabling the user to use the smart phone to access the system. The application may be downloaded via the phone or via the travel website. Preferably the smart phone application includes the following features, which are accessible through an icon: access to the designated savings account to view current funds available; the ability to add funds to the designated savings account; the ability to transfer funds to other members savings accounts; receive alerts form the calendar alert function, send status updates to social media websites; matching funds alerts; limited booking options; and the ability to personalize.

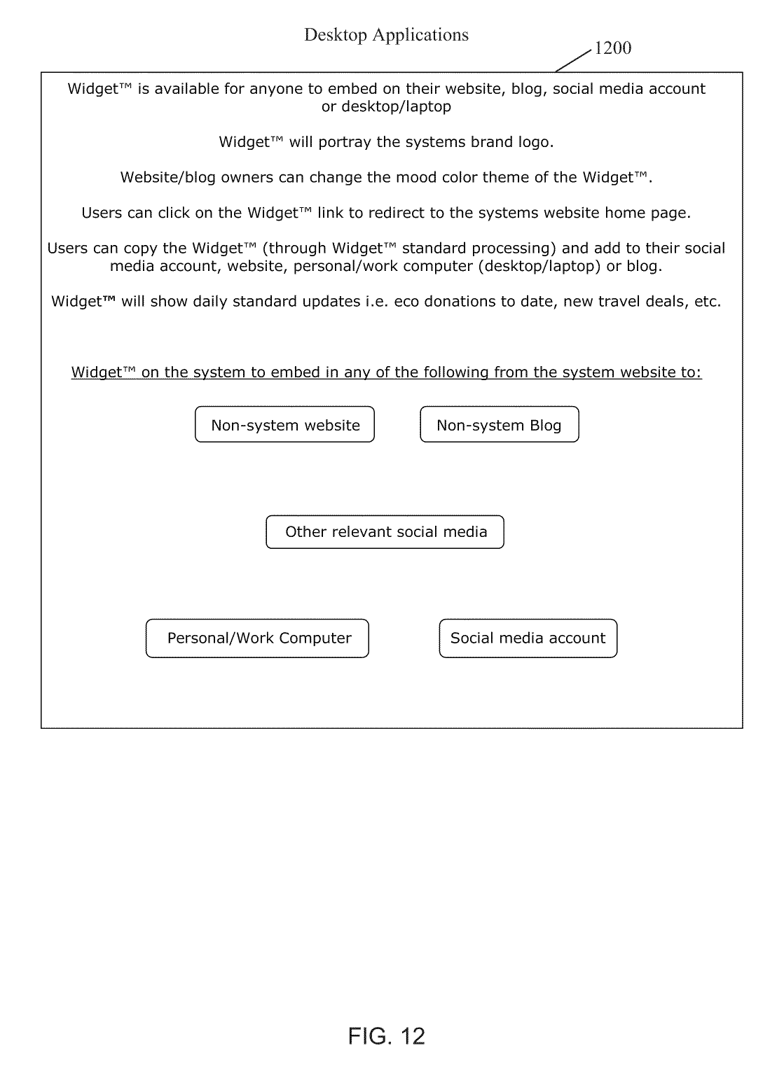

FIG. 12 is a flow block diagram and shows the desktop application options of one embodiment of the present invention. The system, much like a social media website, may be incorporated as links on other websites and desktops through the use of desktop applications, such as Widget™ 1200. Desktop Applications are available for anyone to embed on their website, blog, social media account, or computer desktop. Typically the Widget™ will portray a trademarked logo of the travel system. A widget is also the generic name of the actual link icon that displays the trademarked logo of the system to which it is connected. A widget for the present invention is preferably placed on other non-system websites, blogs, and other relevant social media websites and accounts. The strategic placement of widgets allows members and non-members to connect to the travel system and website. The desktop widget application will preferably show daily updates, such as new deals and donations to charities to date.

The website of the present invention provides a graphical user interface for the user to perform the steps of the present invention. As such, the use of a computer is required to perform the steps of the present invention.

In summary, the present invention is a method of saving for and arranging travel via a full service travel website that is linked to a designated travel savings account. The money in the savings account is used exclusively for purchasing travel on the full service travel website.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A computer-based method of managing travel arrangements, the steps comprising:
registering on a computer by a user on a system for managing travel;
wherein said system for managing travel is on a server;
creating a designated travel savings account;
linking said designated travel savings account to said system for managing travel;
accessing on said computer by said user said system for managing travel;
providing on a computer a plurality of travel options on said system for managing travel to said user accessing said system for managing travel;
selecting by said user one or more of said plurality of travel options on said system for managing travel; and
paying for said selected one or more travel options from a set of saved funds in said designated travel savings account.

2. The computer-based method of managing travel arrangements of claim 1, the steps further comprising:
rewarding said user with one or more rewards points.

3. The computer-based method of managing travel arrangements of claim 2,
wherein said one or more rewards points is based on saving a plurality of funds in said designated travel savings account.

4. The computer-based method of managing travel arrangements of claim 2, wherein said one or more rewards points is based on donating to a charity.

5. The computer-based method of managing travel arrangements of claim 2, wherein said one or more rewards points is based on donating to a carbon offset.

6. The computer-based method of managing travel arrangements of claim 2, wherein said one or more rewards points is based on purchasing travel insurance from said system for managing travel with said set of saved funds in said designated travel savings account.

7. The computer-based method of managing travel arrangements of claim 2, wherein said one or more rewards points is based on purchasing selected one or more travel options from said system for managing travel with said set of saved funds in said designated travel savings account.

8. The computer-based method of managing travel arrangements of claim 2, wherein said rewards points are used by said user to offset paying for said selected one or more travel options.

9. The computer-based method of managing travel arrangements of claim 8, wherein said plurality of travel options provided on said system for managing travel to said user accessing said system for managing travel includes green travel options.

10. The computer-based method of managing travel arrangements of claim 9, wherein said designated travel savings account accrues interest.

11. The computer-based method of managing travel arrangements of claim 10, wherein one or more third parties may add a plurality of additional funds to said set of saved funds in said designated travel savings account.

12. The computer-based method of managing travel arrangements of claim 11, wherein said plurality of travel options includes one or more exclusive deals to registered users from a plurality of travel providers.

13. The computer-based method of managing travel arrangements of claim 12, the steps further comprising:
providing a calendar alert function within said system for managing travel;
inputting a plurality of calendar alert data into said calendar alert function;
wherein said plurality of calendar alert data is selected from the group consisting of future trip data, wish list data, third party gift giving data, personal gift giving data, popular event data, available funds data, funds needed to book a future trip data, and exclusive deals data;
notifying said user by said calendar alert function of one or more of said plurality of calendar alert data.

14. The computer-based method of managing travel arrangements of claim 13, the steps further comprising:
modifying and updating said plurality of calendar alert data.

15. The computer-based method of managing travel arrangements of claim 14, the steps further comprising:
personalizing said system for managing travel; and
personalizing said plurality of calendar alert data.

16. The computer-based method of managing travel arrangements of claim 15, wherein said user is notified by said calendar alert function of one or more of said plurality of calendar alert data by the group consisting of an email notification, a text notification, a smart phone application notification, and a desktop application notification.

17. The computer-based method of managing travel arrangements of claim 2, wherein said designated travel savings account accrues interest.

18. The computer-based method of managing travel arrangements of claim 17, wherein said interest accrued by said designated travel savings account is donated to charity; and
wherein said one or more rewards points is based on donating said interest to charity.

19. The computer-based method of managing travel arrangements of claim 2, wherein said plurality of travel options includes one or more exclusive deals to registered users from a plurality of travel providers.

20. A computer-based method of managing travel arrangements, the steps comprising:
registering on a computer by a user on a system for managing travel;
wherein said system for managing travel is on a server;
creating a designated travel savings account;
linking said designated travel savings account to said system for managing travel;
accessing on said computer by said user said system for managing travel;
providing a on a computer a plurality of travel options on said system for managing travel to said user accessing said system for managing travel;
selecting by said user one or more of said plurality of travel options on said system for managing travel;
paying for said selected one or more travel options from a set of saved funds in said designated travel savings account;
rewarding said user with one or more rewards points;
wherein said one or more rewards points is awarded based on an event selected from the group consisting of saving a plurality of funds in said designated travel savings account, donating to a charity, donating to a carbon offset, purchasing travel insurance from said system for managing travel with said set of saved funds in said designated travel savings account, and purchasing selected one or more travel options from said system for managing travel with said set of saved funds in said designated travel savings account.
wherein said plurality of travel options provided on said system for managing travel to said user accessing said system for managing travel includes green travel options;
wherein said designated travel savings account accrues interest;
wherein one or more third parties may add a plurality of additional funds to said set of saved funds in said designated travel savings account;
wherein said plurality of travel options includes one or more exclusive deals to registered users from a plurality of travel providers;
providing a calendar alert function within said system for managing travel;
inputting a plurality of calendar alert data into said calendar alert function;
wherein said plurality of calendar alert data is selected from the group consisting of future trip data, wish list data, third party gift giving data, personal gift giving data, popular event data, available funds data, funds needed to book a future trip data, and exclusive deals data;
notifying said user by said calendar alert function of one or more of said plurality of calendar alert data;
wherein said user is notified by said calendar alert function of one or more of said plurality of calendar alert data by the group consisting of an email notification, a text notification, a smart phone application notification, and a desktop application notification;
modifying and updating said plurality of calendar alert data;
personalizing said system for managing travel; and
personalizing said plurality of calendar alert data.
